(19) United States
(12) Patent Application Publication
(10) Pub. No.: US 2015/0116391 A1
(43) Pub. Date: Apr. 30, 2015

(54) METHOD AND SYSTEM TO SHARE DISPLAY ATTRIBUTES OF CONTENT

(71) Applicant: Samsung Electronics Co., Ltd., Gyeonggi-do (KR)

(72) Inventors: Kumar MURUGESAN, Bangalore (IN); Adarsha ANANDA, Bangalore (IN); Barath Raj KANDUR RAJA, Bangalore (IN)

(73) Assignee: Samsung Electronics Co., Ltd.

(21) Appl. No.: 14/524,525

(22) Filed: Oct. 27, 2014

(30) Foreign Application Priority Data
Oct. 25, 2013 (IN) 4818/CHE/2013

(51) Int. Cl. G09G 3/20

(52) U.S. Cl. CPC G09G 3/20; G09G 2370/16; G09G 2370/04
USPC 345/698

(57) ABSTRACT

A method, device, and system for sharing at least one display attribute associated with content displayed on the device with a target device is provided. The method includes identifying the at least one display attribute associated with content displayed in a source device, processing the identified at least one display attribute in accordance with an interoperability display ratio, and displaying the content on the target device after applying the processed at least one display attribute to the content. When content is shared between two devices, exchange of display attributes associated with the content helps in ensuring that the user experience of the content is similar at both the source device end and target device.

### PRIORITY

This application claims priority under 35 U.S.C. §119(a) to an Indian Patent Application filed on Oct. 25, 2013 in the Indian Patent Office and assigned Serial No. 4818/CHE/2013, the entire disclosure of which is incorporated herein by reference.

### BACKGROUND

1. Field of the Invention

The present invention relates generally to data sharing in electronic devices and more particularly to sharing display attributes of data between electronic devices through a wireless network.

2. Description of Related Art

Currently, people store content in electronic devices such as computers, mobile phones, Motion Picture expert group layer-3 (MP3) players, Digital Versatile Disc (DVD) players, memory sticks, digital cameras and the like. Sharing this content through electronic devices has become extremely popular. The availability of short range wireless communication facilitates content sharing. The user experience of sharing content may often be compromised due to restrictions, such as user interface and differences in display attributes of the electronic devices, such as screen size, resolution, aspect ratio, and the like. For example, when content is shared between a source device and a target device through a short range communication means, the display of content at the source device may be different than content displayed at the target device, as the target device may have different attributes such as screen size, resolution, aspect ratio and the like.

### SUMMARY

The present invention has been made to address at least the problems and disadvantages described above, and to provide at least the advantages described below.

Accordingly, an aspect of the present invention is to provide a target device configured to automatically convert the received content according to the target device requirement so that the user is not required to alter the received content using editors. The source device sends content along with metadata (i.e. display attributes) and the received content is automatically converted with corresponding brightness, aspect ratio, and the like.

Another aspect of the present invention is to provide a method where the sender device (source device) and the receiver device (target device) share the display attributes associated with content of the source device and the target device, respectively, and content shared will be displayed based on a negotiation between the display attributes of the source device and the display attributes of the target device, respectively.

Another aspect of the present invention is to share display attributes associated with content from a source device to a target device through a wireless network in order to display an interested portion of the content displayed in the source device at the target device directly.

Another aspect of the present invention is to allow for the display attributes associated with the content of the source device to be processed based on the target device's display capabilities, thereby maintaining the quality and originality associated with the content of the source device when shared with the target device.

In accordance with an aspect of the present invention, a method for sharing at least one display attribute associated with content displayed in a source device with a target device is provided. The method includes identifying at least one display attribute associated with the content by the source device, processing the identified at least one display attribute in accordance with an interoperability display ratio, displaying the content on the target device after applying the processed at least one display attribute to the content.

In accordance with another aspect of the present invention, a system for sharing at least one display attribute associated with content is provided. The system includes a source device for identifying at least one display attribute associated with a displayed content, and sending the identified at least one display attribute and the content, and a target device for processing the identified at least one display attribute in accordance with an interoperability display ratio, displaying the content on the target device after applying the processed at least one display attribute to the content.

In accordance with another aspect of the present invention, a device for sending at least one display attribute associated with content of the device to a target device is provided. The device includes at least one processor and at least one memory. The memory has recorded thereon a computer program. The at least one processor is configured to identify at least one display attribute associated with the content displayed in the device, and send the identified at least one display attribute to the target device.

In accordance with another aspect of the present invention, a device for receiving at least one display attribute associated with content from a source device is provided. The device includes at least one processor and at least one memory. The memory has recorded thereon a computer program. The at least one processor is configured to process the at least one display attribute received from the source device in accordance with an interoperability display ratio, and display the content after applying the processed at least one display attribute to the content.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a block diagram illustrating an electronic device with various modules, according to an embodiment of the present invention;

FIG. 2 is a flow diagram illustrating the process of sharing identified display attributes of content at a source device, according to an embodiment of the present invention;

FIG. 3 illustrates a Near field communication Data Exchange Format (NDEF) record used for transferring display attributes through Near Field Communication (NFC), according to an embodiment of the present invention;

FIG. 4 is a flow diagram illustrating the steps of processing received display attributes at a target device, according to an embodiment of the present invention;

FIG. 5 illustrates an example in which a document is shared between a source device and a target device through NFC, according to an embodiment of the present invention;

FIGS. 6A and 6B illustrate an example in which a webpage is shared between a source device and a target device using NFC, according to an embodiment of the present invention;

FIG. 7 illustrates an example in which an image is shared between a source device and a target device using NFC, according to an embodiment of the present invention;

FIG. 8 illustrates an example in which a video is shared between a source device and a target device using NFC, according to an embodiment of the present invention; and

FIG. 9 is a block diagram illustrating a computing environment, according to an embodiment of the present invention.

### DETAILED DESCRIPTION OF EMBODIMENTS OF THE PRESENT INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments of the present invention. The examples used are intended merely to facilitate an understanding of ways in which the embodiments of the present invention can be practiced and to further enable those of skill in the art to practice the embodiments of the present invention. Accordingly, the examples should not be construed as limiting the scope of the embodiments of the present invention.

The embodiments of the present invention achieve a method and system to share one or more display attributes of content displayed on a display of an electronic device during a content sharing session between a source device and a target device. The method identifies display attributes of a content displayed on the source device. When the user of the source device shares the content with the target device, the identified display attributes is sent to the target device after establishing a connection between the source device and the target device using a wireless communication.

The display attributes of the content received at the target device are compared with the display attributes of the target device and an interoperability display ratio is identified. The received display attributes of content are modified based on the identified interoperability display ratio. The modified display attributes are applied to the received content and displayed on the target device.

The target device, after receiving the display attributes of the content from the source device, identifies the interoperability display ratio of the source device and the target device.

The display attributes associated with the content can include, but are not limited to, zoom level, page number, position on screen, visible region, pan, scroll, pixels per inch, resolution, brightness, contrast, screen size, depth of device and page orientation.

Throughout the description, the terms electronic device, source device and target device are used interchangeably. An electronic device is capable of acting both as the source device and target device.

In an embodiment of the present invention, the source device and the target device are similar devices. For example, the source device can be a smart phone and the target device can be a mobile phone.

In another embodiment of the present invention, the source device and target device are different devices. For example, the source device can be a mobile device and the target device can be a tablet.

An electronic device (i.e., a source device) can share content with one or more target devices. The content can be a document, image, webpage, audio, video, contacts, and the like.

Examples of an electronic device include, but are not limited to, a mobile phone, smart phone, computer, laptop, Personal Digital Assistant (PDA), Digital Versatile Disc (DVD) player, a camera and the like. Any connected device with display capabilities can be configured to share display attributes (e.g., a wearable watch).

The method and system disclosed herein is dynamic, robust, and reliable for sharing display attributes associated with content, as well as for sharing content for an improved user experience. The sharing of display attributes related to the content being shared, rather than sharing the display attributes of the source device, ensures that the region of interest in the content displayed on the source device is the same as that displayed on the target device. Consider an example when the business section in a news based webpage is shared between the source device and the target device. The articles in the business section can be the region of interest which the user of the source device wants to share. In the proposed method, based on the received display attributes which include the region of interest, i.e. the business section, the target device displays the webpage showing the business section in the received webpage. Other display attributes like zoom level, brightness, aspect ratio, scroll, pan, and the like, associated with the webpage can also be shared between the source device and the target device. This ensures that the quality and originality of the content is maintained in the target device. The use of payload in a communication message is a simple way to share the display attributes and does not require any complicated implementation.

In an embodiment of the present invention, the wireless communication can include, but is not limited to, Bluetooth, Wi-Fi, InfraRed (IR), NFC, and the like.

With reference to the drawings, where like reference numbers and characters denote corresponding features consistently throughout the figures, there are shown preferred embodiments.

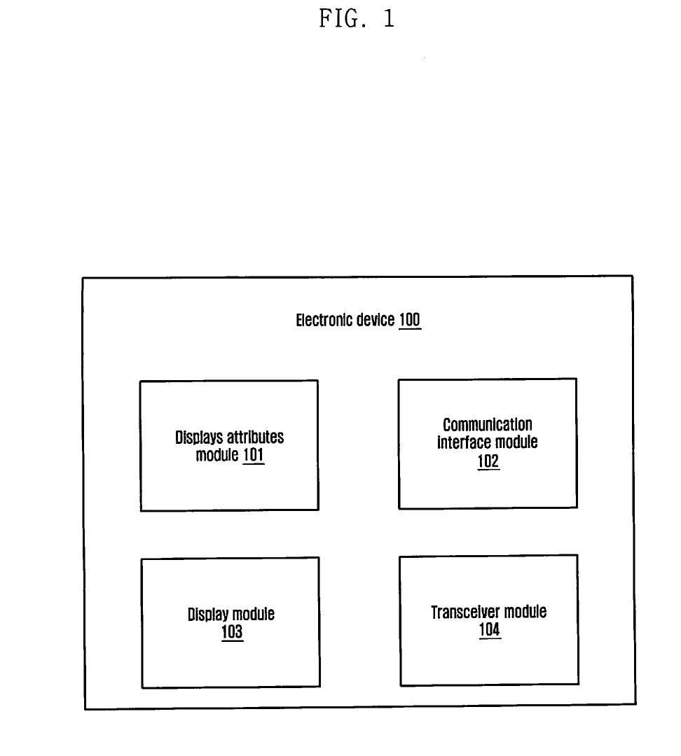

FIG. 1 is a block diagram illustrating an electronic device 100 with various modules, according to an embodiment of the present invention.

Referring to FIG. 1, electronic device 100 is shown. The electronic device 100 includes a display attributes module 101, a communication interface module 102, a display module 103, and a transceiver module 104. The display attributes module 101 identifies a set of display attributes associated with the content displayed on the electronic device 100. The display attributes module 101 is configured to identify the display attributes of the content when the user of the electronic device 100 wants to share the content with another electronic device. The content present on the display of the electronic device 100 is displayed using a display module 103. The display module 103 is configured to display content on the user display/screen based on input received from the display attributes module 101 The display attributes module 101 is configured to send the identified display attributes along with the content to another electronic device. Once a source device (i.e., an electronic device sharing content) is paired with a target device (i.e., an electronic device receiving the shared content), the display attributes associated with content are sent through a payload of a communication message. The transceiver module 104 ensures that the electronic device 100 is capable of sending and receiving data. The source device and the target device are paired using a communication interface module 102. The communication interface module 102 allows the electronic device 100 to share and receive data through a wireless communication network such as Bluetooth, Wi-Fi, NFC, and the like. Once the source device is paired with the target device, the identified display attributes and the content can easily be shared between the source device and the target device. At the target device, the display attributes module 101, on receiving content, checks for the presence of display attributes in the payload of a communication message. The display attributes module 101 is configured to identify the interoperability display ratio by comparing the display attributes of the content received in the payload and display attributes of the target device, and process the received display attributes according to the identified interoperability display ratio.

The display attributes module 101 applies the processed display attributes on the received content and displays it to user through the display module 103.

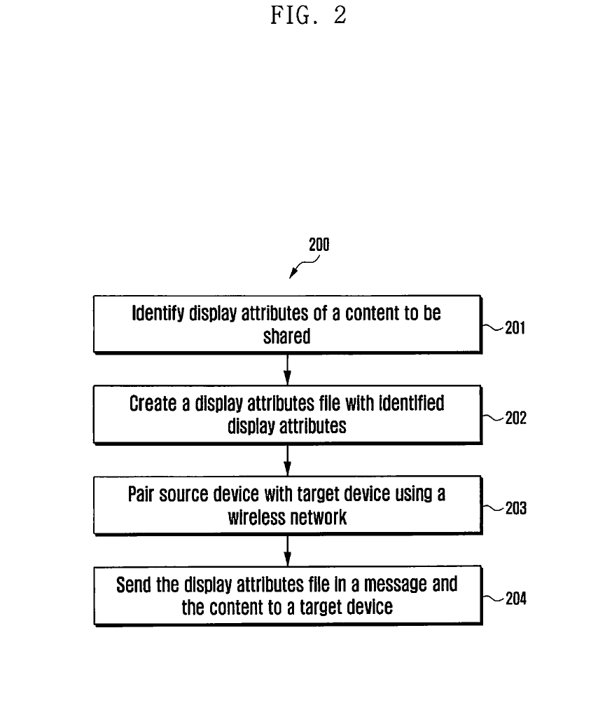

FIG. 2 is a flow diagram illustrating the process of sharing identified display attributes of content at a source device, according to an embodiment of the present invention.

Referring to FIG. 2, a flowchart 200 is shown. At step 201, the display attributes module 101 is configured to identify the display attributes associated with the content which is to be shared at the source device. At step 202, the source device creates a file containing all of the display attributes associated with the content. The display attributes in the file depend on the type of content being shared. For example, if an image is being shared, the display attributes may include a size of the image, screen size, pixels per inch, brightness of the screen, zoom level, scroll, pan, and the like. At step 203, the source device and the target device are paired using a wireless network. Examples of such wireless network include, but are not limited to, Bluetooth, Wi-Fi, IR, NFC, and the like. The communication interface module 102 allows the source device and target device to establish a connection. At step 204, the display attributes file and the content are shared from the source device to one or more paired target devices. The source device and the target device can be paired using NFC. An NFC enabled source device and NFC enabled target device can paired by bringing them close together. The source device sends the display attributes file in a message to the target device. The payload of the message contains the display attributes file. The various actions shown in flow diagram 200 may be performed in the order presented, in a different order or simultaneously. Further, according to some embodiments of the present invention, some actions may be omitted.

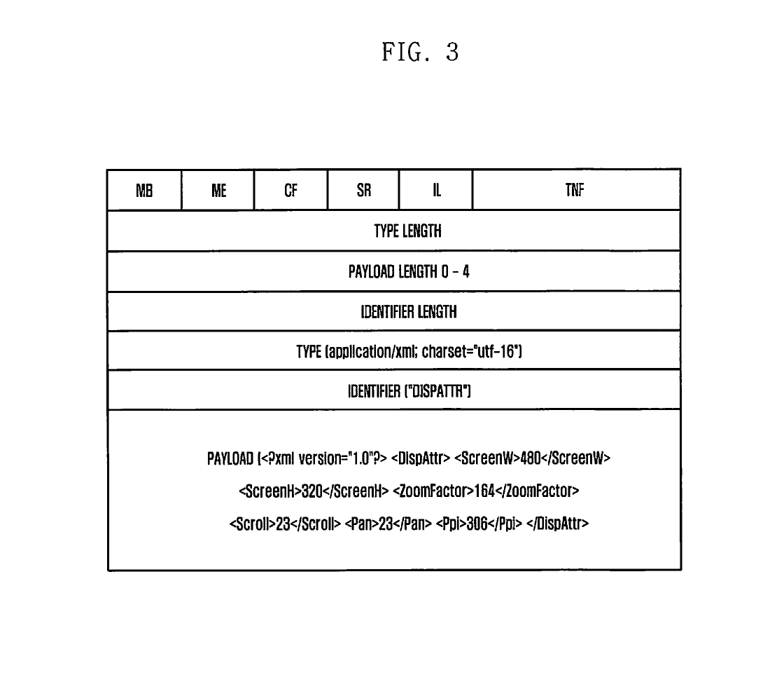

FIG. 3 illustrates a NDEF record used for transferring display attributes through Near NFC, according to an embodiment of the present invention.

Referring to FIG. 3, an NDEF record is shown. The NDEF specification defines a message encapsulation format using for exchanging information. A single NDEF message can contain multiple NDEF records. The NDEF record contains a payload LENGTH and a payload TYPE, along with an identifier. The use of an identifier enables payloads that support Uniform Resource Identifier (URI) linking technologies to cross-reference other payloads. The payload includes control information associated with NDEF record and other payload data. In an embodiment of the present invention, the NDEF record can be used to encapsulate one or more application related data defined in the payload. The NDEF record is exchanged between the NFC agents of the source device and the target device in a peer to peer mode using an NDEF exchange protocol. The payload field contains the display attributes file associated with a content displayed on the source device. FIG. 3 shows a payload containing display attributes related to content displayed on the source device. An identifier, called “DISPATTR”, associated with the display attributes file is also shown in the FIG. 3. Although FIG. 3 describes an NDEF record's payload used for encapsulating the display attributes associated with content in NFC, it should be understood that this is merely an illustrative embodiment and display attributes can be encapsulated in the payload of communication message of different wireless networks.

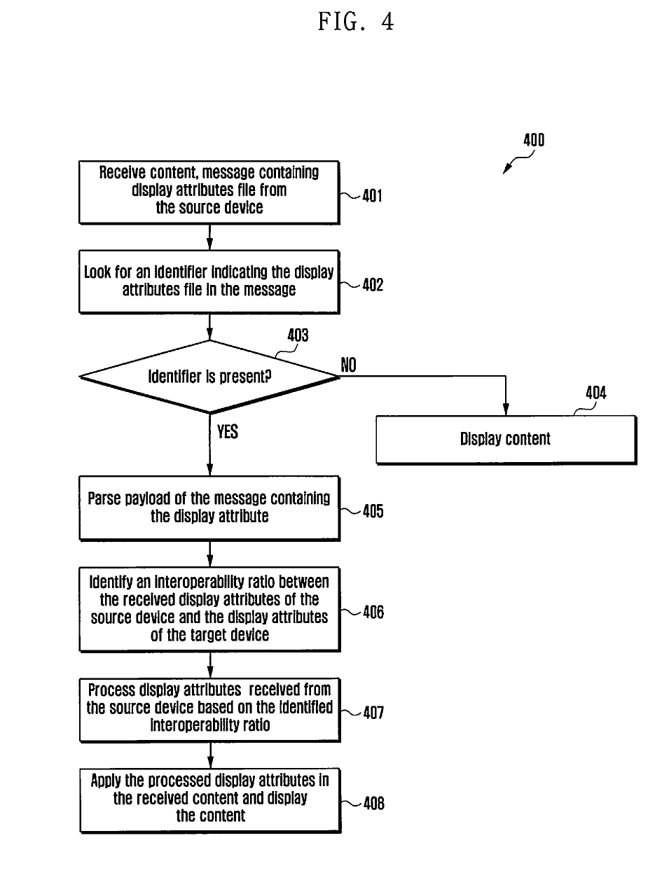

FIG. 4 is a flow diagram illustrating the steps of processing received display attributes at a target device, according to an embodiment of the present invention.

Referring to FIG. 4, a flow diagram 400 is shown. At step 401, the receiver device (e.g., target device) is configured to receive, from the source device, the content and the message containing the display attributes of the content. At step 402, the display attributes module 101 looks for an identifier indicating the presence of a display attributes file in the received message. At step 403, the system checks for the presence of the identifier in the received message. At step 404, if the identifier is absent, then the content received is displayed at the receiver device using the display module 103. At step 405, if the identifier is present, then the payload in the message is parsed to retrieve the display attributes associated with the received content. An XML parser may be used to retrieve the display attributes when the display attributes are sent in an XML file. At step 406, after the display attributes are retrieved, the display attributes module 101 identifies the interoperability display ratio between the received display attributes of the content from the source device and the display attributes of the target device. The method of identifying the interoperability display ratio can include, but is not limited to, identifying a ratio between the resolution of the source device and a target device, identifying zoom/pan/scroll factors between the source device and the target device. At step 407, the display attributes received are processed based on the identified interoperability display ratio. At step 408, the processed display attributes are then applied to the received content and the content is displayed on the target device. The various actions in flowchart 400 may be performed in the order presented, in a different order or simultaneously. Further, according to some embodiments of the present invention, some actions may be omitted.

Consider an example, when a source device having a resolution of 1024*780 sends an image to a target device with a resolution of 720*480. For calculating the zoom level at the target device, the following Equation (1) is performed:

$$targetWidthZoomFactor = ( \frac{screenWidthtarget}{screenWidthsource} ) * sourceWidthZoomlevel \qquad ( 1 )$$

For calculating the zoom factor of the content at target device, the target device screen width (e.g., the resolution of the target device) and the source device screen width (e.g., the display attributes of the content or the resolution of the content) are considered. Similar calculations may be performed for other display attributes associated with the content.

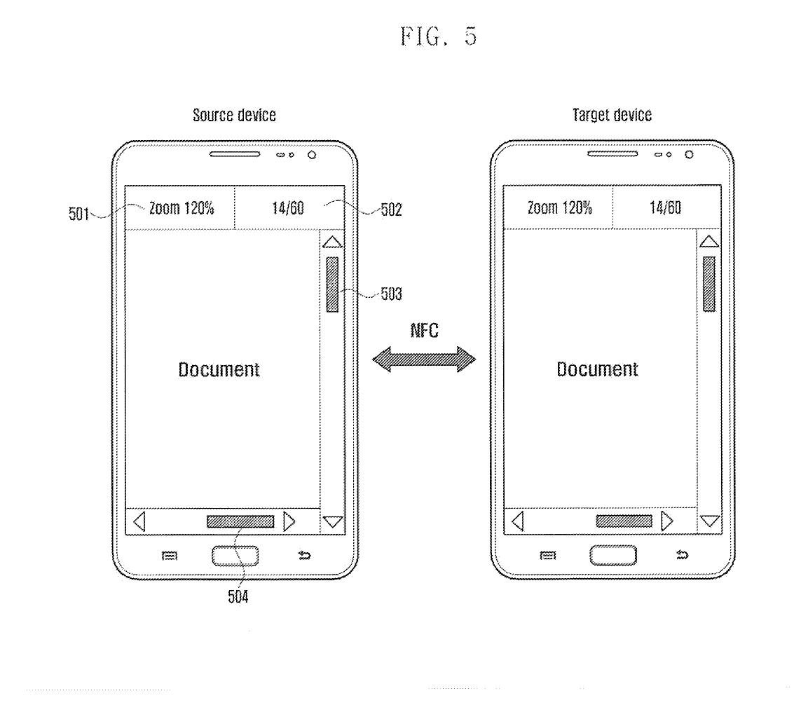

FIG. 5 illustrates an example in which a document is shared between a source device and a target device through NFC, according to an embodiment of the present invention.

Referring to FIG. 5, a source device and a target device paired using NFC are shown. The source device and a target device display the same document after the document is shared between the source device and the target device, as shown in FIG. 5. Examples of a document include, but are not limited to, spreadsheet, PDF, text document, presentation, and the like. As shown in FIG. 5, at the source device the zoom level of the document is 120% (501) and the page number (502) is 14 out of 60. The vertical scroll level (503) and horizontal scroll level (504) is shown in the figure. When the document is shared, the document opens the same way on the target device as it is displayed on the source device. The target device shows 120% zoom level and page number 14 is also shown along with the same scroll level. The target device identifies the interoperability display ratio between the received display attributes and the display attributes of the target device. Based on the identified interoperability display ratio, the received display attribute associated with the content is processed and applied to the content at the target device. The content displayed at the target device is the same as that of the source device and displays the same region of interest as displayed on the source device.

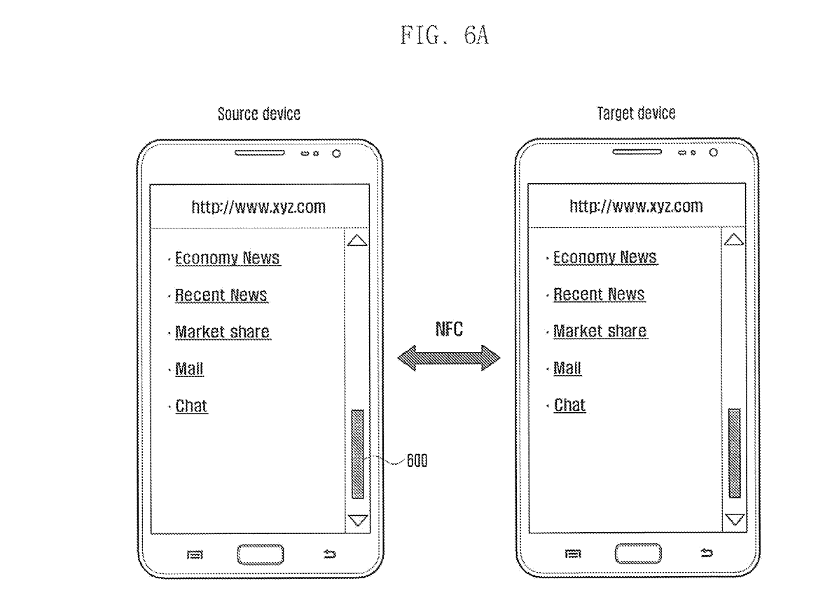

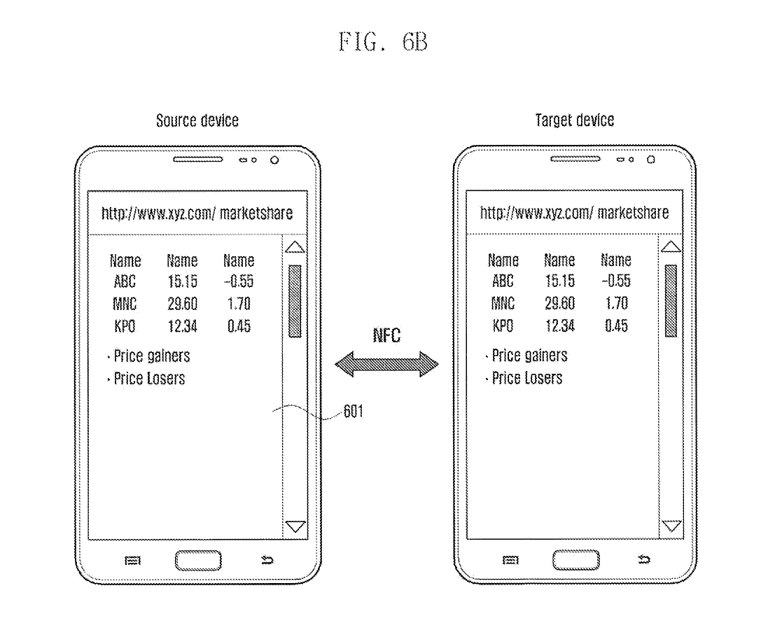

FIGS. 6A and 6B illustrate an example in which a webpage is shared between a source device and a target device using NFC, according to an embodiment of the present invention.

Referring to FIG. 6A, a web page with various sub contents like economy news, market share, recent news, blogs, mail, chat, and the like is shown. The user at source device scrolls down, as shown by reference numeral 600, to reach the market share section in the webpage. When the webpage is shared, it opens the same way at the target device as displayed on the source device, and on the target device, the displayed web page directly scrolls down to the market share section.

Referring to FIG. 6B, when the user of source device views the content present inside the market share section 601 and shares the webpage with the target device, the target device receives the content and displays the webpage as displayed on the source device. As shown in FIG. 6B, the market share section 601 is displayed at the target device. When the source device shares the webpage, the display attribute related to the content on display is identified. In this example, the section of market share 601 is the region of interest, which the user of the source device wants to share with the target device. In this example, the display attributes include identifying the position of the details corresponds to the market share section 601, the zoom level, the brightness, position of the information, and other details. On receiving the display attributes, the target device identifies the interoperability display ratio between the received display attributes of the webpage and the display attributes of the target device. Based on the identified interoperability display ratio, the received display attribute is processed and applied to the content at the target device. The content displayed at the target device is the same as that shared by the source device and displays the same region of interest (i.e., market share section 601) as displayed on the source device.

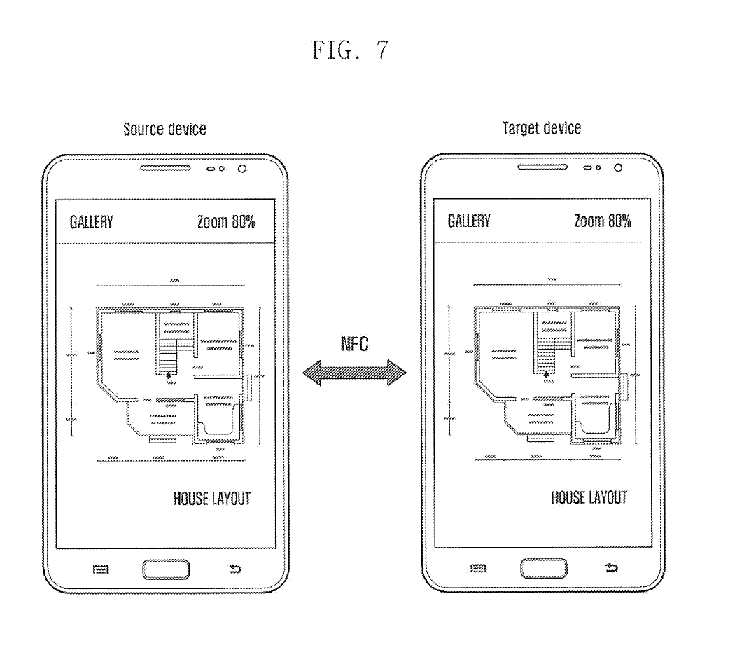

FIG. 7 illustrates an example in which an image is shared between a source device and a target device using NFC, according to an embodiment of the present invention.

Referring to FIG. 7, an image of a house layout present in the image gallery of the source device is shown. When the user of source device views the image of the house layout at 80% zoom, for example, and shares the image with target device, the target device receives the image of the house layout and displays the image of the house layout at 80% zoom level as displayed on the source device. When the source device shares the image of the house layout, the display attributes related to the house layout on display is identified. In this example, one of main display attributes may include viewing of the house layout at 80% zoom level. Some features of the house layout shown at 80% zoom can be the region of interest on the image which the user of the source device wants to share with the user of the target device. The source device and the target device are paired using NFC. The target device identifies the interoperability display ratio between the received display attributes associated with the image and display attributes of the target device. Based on the identified interoperability display ratio, the received display attributes associated with the house layout are processed and applied to the image received at the target device. The image displayed at the target device is the same as that displayed on the source device and displays the same region of interest as displayed on the source device.

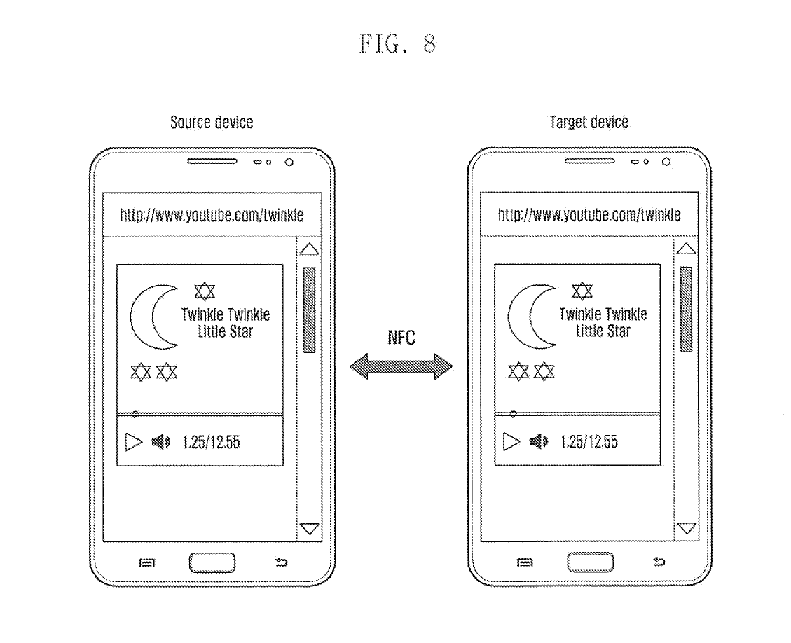

FIG. 8 illustrates an example in which a video is shared between a source device and a target device using NFC, according to an embodiment of the present invention.

Referring to FIG. 8, a video on a webpage at the source device is shown. When the user of source device views the video and pauses at the 1.25 second mark, with 60% volume, for example, and shares the video with the target device, the target device receives the video and displays the paused video at the 1.25 second mark, with 60% volume, as displayed on the source device. When the source device shares the video, the display attribute related to the video on display is identified. In this example, the video paused at the 1.25 seconds mark, with 60% volume is the region of interest, which the user of the source device wants to share with the target device. The source device and the target device are paired using NFC. The target device identifies the interoperability display ratio between the received display attributes of the video and display attributes of the target device. Based on the identified interoperability display ratio, the received display attributes are processed and applied to the video at the target device. The video displayed at the target device is then the same as that displayed at the source device and highlights the same region of interest as displayed on the source device.

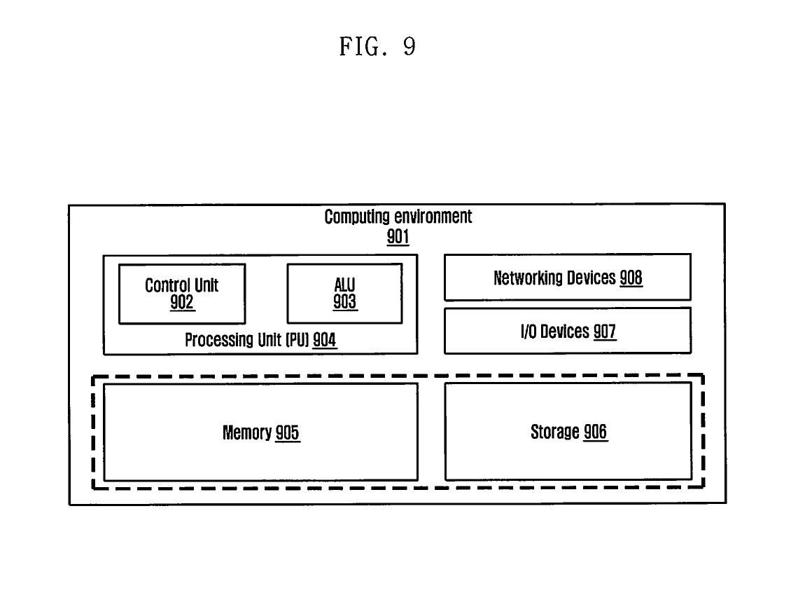

FIG. 9 is a block diagram illustrating a computing environment, according to an embodiment of the present invention.

Referring to FIG. 9, a computing environment implementing a method of sharing display attributes associated with content between devices through a wireless network is shown.

As shown, the computing environment 901 includes at least one processing unit 904 that is equipped with a control unit 902 and an Arithmetic Logic Unit (ALU) 903, a memory 905, a storage unit 906, plurality of networking devices 908 and a plurality Input output (I/O) devices 907. The processing unit 904 is responsible for processing instructions of an algorithm. The processing unit 904 receives commands from the control unit 902 in order to perform its processing. Further, any logical and arithmetic operations involved in the execution of the instructions are computed with the help of the ALU 903.

The overall computing environment 901 can be composed of multiple homogeneous and/or heterogeneous cores, multiple CPUs of different kinds, special media and other accelerators. Further, the plurality of processing units 904 may be located on a single chip or over multiple chips. The algorithm comprising instructions and codes required for implementation of the methods of the present invention are stored in either the memory 905 or the storage 906 or both. At the time of execution, the instructions may be fetched from the corresponding memory 905 and/or storage unit 906, and executed by the processing unit 904.

In the case of hardware implementations, various networking devices 908 or external I/O devices 907 may be connected to the computing environment to support the implementation of the method.

The embodiments disclosed herein can be implemented through at least one software program running on at least one hardware device and performing network management functions to control the elements. The elements shown in FIGS. 1, 5, 6, 7, 8, and 9 include modules which can be implemented by at least one of a hardware device, or a combination of hardware a device and a software module.

The foregoing description of the specific embodiments reveals the general nature of the embodiments of the present invention such that others can, by applying current knowledge, readily modify and/or adapt for various applications, such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the present invention have been described in terms of preferred embodiments, those skilled in the art will recognize that the embodiments of the present invention can be practiced with modification within the spirit and scope of the embodiments as described herein.

What is claimed is:

1. A method for sharing at least one display attribute associated with content displayed in a source device with a target device, the method comprising:
identifying at least one display attribute associated with the content by the source device;
processing the identified at least one display attribute in accordance with an interoperability display ratio; and
displaying the content on the target device after applying the processed at least one display attribute to the content.

2. The method of claim 1, further comprising identifying the interoperability display ratio between the identified at least one display attribute and at least one display attribute of the target device.

3. The method as in claim 2, identifying the interoperability display ratio comprises comparing the identified at least one display attribute with the at least one display attribute of the target device.

4. The method as in claim 1, further comprising pairing the source device and the target device to share the identified at least one display attribute.

5. A system for sharing at least one display attribute associated with content, the system comprising:
a source device for identifying at least one display attribute associated with a content displayed, and sending the identified at least one display attribute and the content; and
a target device for processing the identified at least one display attribute in accordance with an interoperability display ratio, displaying the content on the target device after applying the processed at least one display attribute to the content.

6. The system of claim 5, wherein the target device identifies the interoperability display ratio between the identified at least one display attribute and at least one display attribute of the target device.

7. The system of claim 6, wherein the target device identifies the interoperability display ratio by comparing the identified at least one display attribute with the at least one display attribute of the target device.

8. The system of claim 5, wherein the source device shares the identified at least one display attribute with the target device through pairing.

9. A device for sending at least one display attribute associated with content displayed in the device to a target device, wherein the device comprises:
at least one processor; and
at least one memory having recorded thereon a computer program,
wherein the at least one processor is configured to:
identify at least one display attribute associated with the content displayed in the device; and
send the identified at least one display attribute to the target device.

10. A device for receiving at least one display attribute associated with content from a source device, wherein the device comprises:
at least one processor; and
at least one memory having recorded thereon a computer program,
wherein the at least one processor is configured to:
process at least one display attribute received from the source device in accordance with an interoperability display ratio; and
display the content after applying the processed at least one display attribute to the content.

11. The device of claim 10, wherein the at least one processor is further configured to identify the interoperability display ratio between the at least one display attribute associated with the content received from the source device and at least one display attribute of the device.

12. The device as in claim 11, wherein identifying the interoperability display ratio comprises comparing the at least one display attribute associated with the content received from the source device with the at least one display attribute of the device.
